(19) United States
(12) Patent Application Publication
(10) Pub. No.: US 2012/0007361 A1
(43) Pub. Date: Jan. 12, 2012

(54) Water Handling Environment Water Electric Generator

(76) Inventor: Pete Agtuca, Auburn, WA (US)

(21) Appl. No.: 13/180,381

(22) Filed: Jul. 11, 2011

Related U.S. Application Data
(60) Provisional application No. 61/362,715, filed on Jul. 9, 2010.

(51) Int. Cl. H02P 9/04; H02P 9/00

(52) U.S. Cl. 290/43; 322/35

(57) ABSTRACT

A variable volume and velocity water electric generator system for use in a narrow channel in which variable amounts of water flow. The system includes an electric generator/water wheel unit mounted on a rigid frame vertically aligned within the channel. The unit includes an electric generator and the water wheel assembly that are axially aligned. When the frame is vertically aligned and lowered into the channel, the water wheel assembly is transversely aligned in the channel and its fixed vanes optimally positioned into the path of the water flowing through the channel. The generator's outer casing is connected to an end plate on the water wheel assembly so that the outer casing and the water wheel assembly rotates as one unit. A programmable inverter is connected to the generator that measures the voltage output and controls the amperage load exerted on the electric generator to electrical power extracted from the water is optimized. The water wheel assembly is connected to an optional winch and a sensor that automatically lowers and raises the water wheel assembly on the frame according to the level of water flowing in the channel so that the vanes are optimally positioned in the flow of water

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

This utility patent application is based upon and claims the filing date benefit of U.S. provisional patent application (Ser. No. 61362715) filed on Jul. 9, 2010.

### BACKGROUND OF THE INVENTION

1. Field of the Invention

This invention pertains to water electric generators, and more specifically to scalable water generators specifically designed for use in a water handling environment.

2. Description of the Related Art

There are thousands of different water handling environments where variable, large volumes of water flow continuously through a partially exposed, narrow channel. Examples of such environments are waste water treatment facilities, flood control facilities and water irrigation facilities. Such facilities typically have a narrow, U-shaped channel made of concrete through which thousands or millions of gallons of water flow daily. The volume and rate of flow of water through the channel can vary minute to minute.

Disclosed herein is a water electric generator system specifically designed to be used in these water handling environments with partially open, narrow channels in which variable volumes of water flow.

### SUMMARY OF THE INVENTION

Disclosed herein is a water electric generator system designed to produce electricity from a relatively low to moderate volume of water flowing continuously but at different rates through a U-shaped channel. The system includes an electric generator/water wheel unit transversely aligned inside the U-shaped channel and mounted on a vertical, rigid frame that also fits inside the channel. The frame is designed to be adjustable in length and width for different size channels. The electric generator/water wheel unit includes an electric generator coupled to a water wheel. The electric generator/wheel wheel unit is adjustably attached to the frame thereby enabling an operator to adjust the location of the water wheel on the frame to accommodate different water levels in the channel so that the water wheel vanes are optimally positioned optimally in the flow of the water as all times.

More specifically, the electric generator/water wheel unit includes two vertical plates designed to move vertically along the frame's two legs located on opposite sides of the channel. Disposed between the vertical plates are support struts. Mounted on the frame is an optional height adjustment mechanism that is used to raise or lower the water wheel assembly on the frame according to the level of the water in the channel. A water level measuring device is connected to the height adjustment mechanism that automatically rises or lowers the water wheel and generator assembly on the frame according to the water level.

The water wheel includes two opposite first and second end plates held apart by a plurality of fixed vanes. Extending transversely between the two end plates is a centrally aligned axle. The axle extends through the first end plate and connects to a hub located on the inside surface of the first vertical plate.

Coaxially aligned and mounted to the outside surface of the water wheel's second end plate is a low RPM electric generator. The electric generator includes a water tight outer casing that is mounted directly to the second end plate. Located on the inside surfaces of the outer casing are two parallel, flat magnetic discs. The outer casing is sufficiently wide and the two magnetic discs are sufficiently spaced apart to form a center gap in which a stator disc is located. The stator disc is mounted and fixed to a coaxially aligned, hollow support shaft that extends from the outer casing and connects to a second hub centrally located on the second vertical plate. The stator disc includes a plurality of looped coil members radially aligned and embedded therein. During operation, the outer casing and the magnetic discs rotated around the support axle and around the stator disc which produces a three phase A.C. electric current.

A software programmable inverter is electrically connected to the electric generator that allows the operator to selectively adjust the output of the generator's load according to the actual volume and flow rate of the water flowing through the channel.

During setup, the baseline output for the generator is established based on a pre-determine volume and velocity of the water flowing through the water channel. When the level of the water is lowered or raised, the amount of water flowing against the vanes of the water wheel changes, causing the output of the generator to change. In one embodiment, the location of the water wheel assembly is automatically adjusted on the frame so that the water wheel will remain located in the main flow of the water so that the electrical output of the generator is optimized at all times.

### DESCRIPTION OF THE DRAWINGS

FIG. 1 is a perspective view of the variable water electric generator system shown inside a narrow, U- shaped channel and downstream from a spillway.

FIG. 2 is a side elevational view of the water electric generator system located inside the U-shaped channel and downstream from a spillway.

FIG. 3 is a bottom plan view of the water electric of the water electric generator system.

FIG. 4 is an exploded, front perspective view of the water electric generator system.

FIG. 5 is a front, exploded perspective view of the water electric generator assembly.

FIG. 6 is a rear, exploded perspective view of the water electric generator assembly.

FIG. 7 is an exploded, front elevational view of the variable water electric generator system

FIG. 8 is a perspective view of a support leg showing a guide located inside a channel formed in the support leg and the vertical plate being attached to the guide.

FIG. 9 is an exploded, perspective view of the generator.

FIG. 10 is an illustration of the menu page generated the maximum power point tracking software program that is used to adjust the load on the generator assembly so that it operates efficiently.

FIG. 11 is a flow diagram showing how the generator connected to the household electrical grid.

### DESCRIPTION OF THE PREFERRED EMBODIMENT(S)

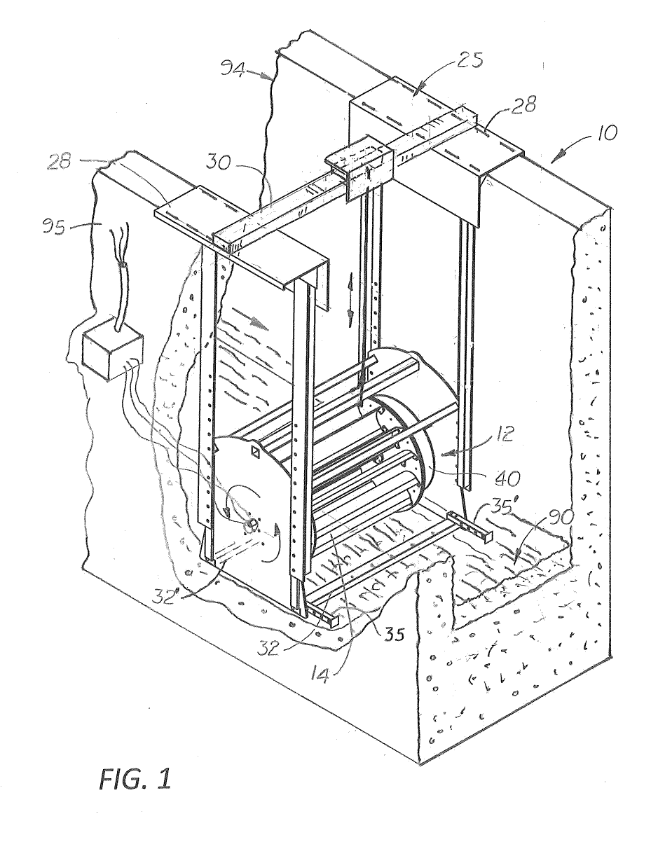

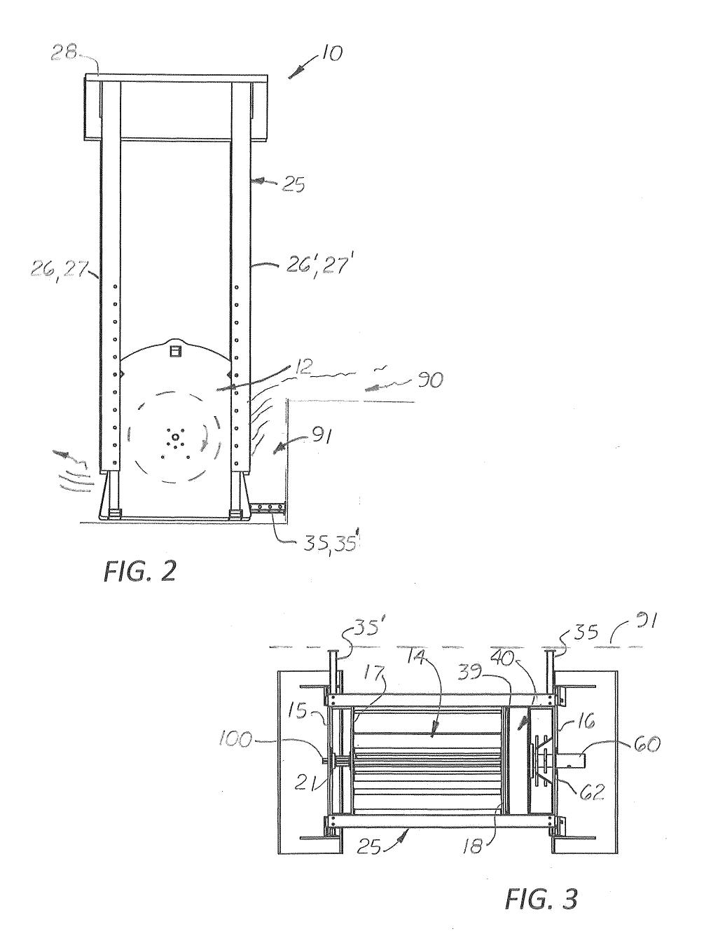

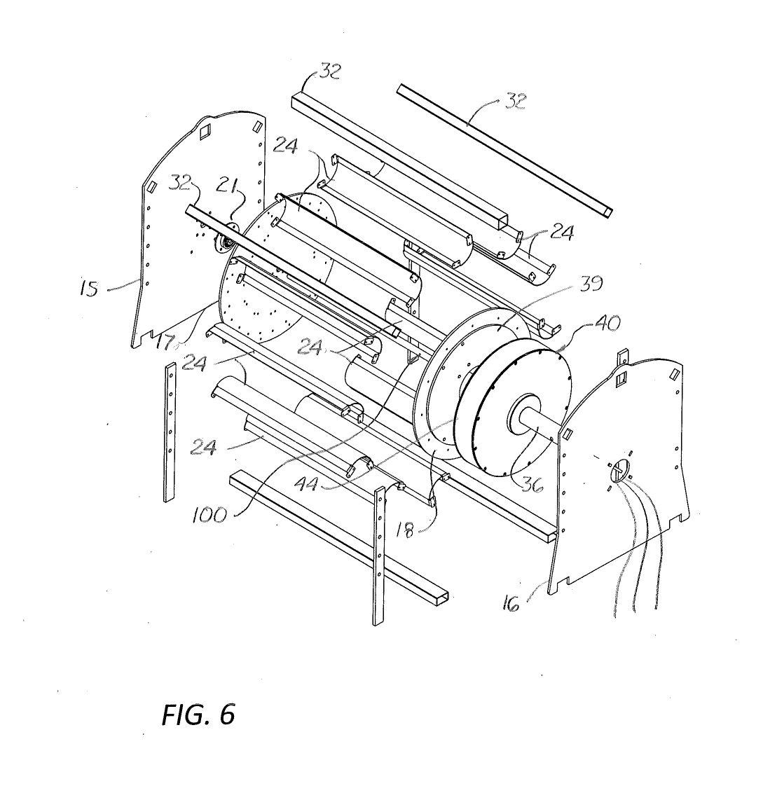

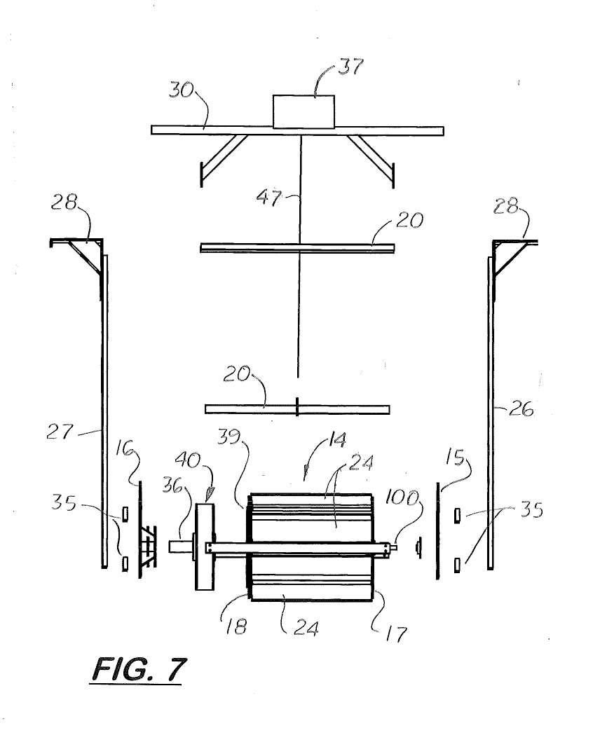

Referring to the accompanying FIGS. 1-11, there is shown a variable water electric generator system 10 used to generate electricity from a relatively low to moderate volume of water 90 flowing continuously through an exposed, U-shaped channel 94. The system 10 includes an electric generator/water wheel unit 12 mounted on the lower portion of a vertical frame 25 designed to extend vertically and transversely into the channel 94. The electric generator/water wheel assembly unit 12 includes an axially aligned water wheel assembly 14 and a low RPM electric generator 40 adjustably mounted on the frame 25. The overall length of the electric generator/water wheel unit 12 is sufficient to extend substantially the entire width of the channel 94. The electric generator 12 includes a relatively thin outer casing 42 so that most of the water 90 flowing in the channel 94 is exerted against the vanes 24 on the water wheel unit 12.

During setup, the location of the electric generator/water wheel unit 12 on the frame 25 is adjusted so that the vanes 24 on the water wheel 14 are optimally located in the downstream flow of the water 90 for optimal rotation of the water wheel 14 assembly. During setup, the height and width of the frame 25 and the length of the vanes 24 also may be adjusted for different size channels 94. In one embodiment, the relative location of the water electric generator/water wheel unit 12 may be automatically adjusted on the frame 25 according to the changing level of water 90 flowing in the channel 94.

The frame 25 includes four vertical legs 26, 26′, 27, 27′ and extend vertically inside and adjacent to the side walls 95 of the channel 94. The upper ends of two vertical legs 26, 26′ and 27, 27′are attached to an inverted, L-shaped rigid bracket 28, 28′, respectively, that extends over the top edge of the side wall 95. The brackets 28, 28′ vertically hold the two pairs of legs 26, 26′ and 27, 27′ in a relatively fixed position over the side walls 95. Extending transversely over the top surfaces of the two brackets 28, 28′ is a centrally aligned, horizontal support member 30. Optional diagonally aligned braces may be provided for additional support.

Extending between the upper and lower ends of the legs 26, 26′ and 27, 27′ and extending transversely across the channel 94 are two upper horizontal support members 31, 31′ and two lower horizontal support members 32, 32′, respectively. Also, extending between the legs 26, 26′ and 27, 27 adjacent to a channel side wall are plurality of optional diagonal braces 34, 34′, respectively.

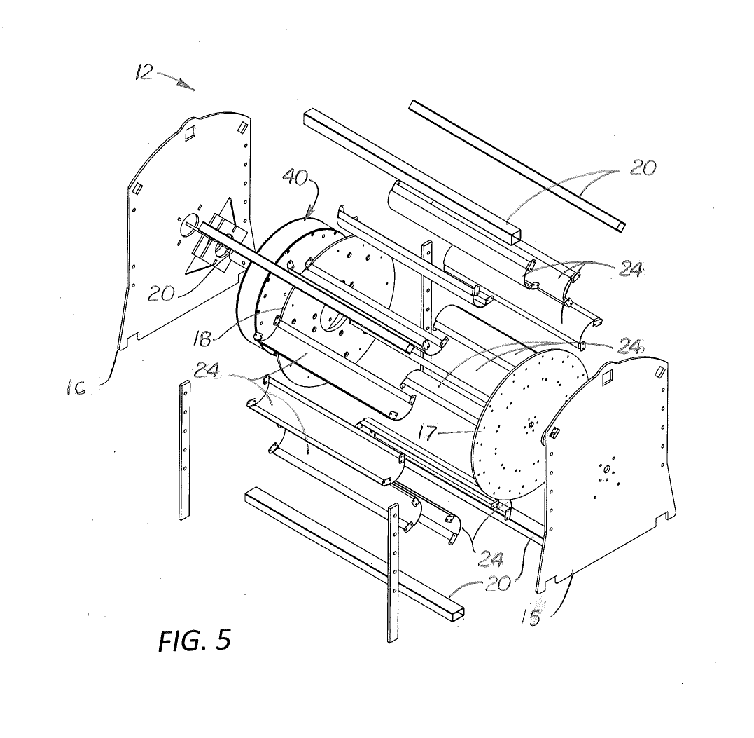

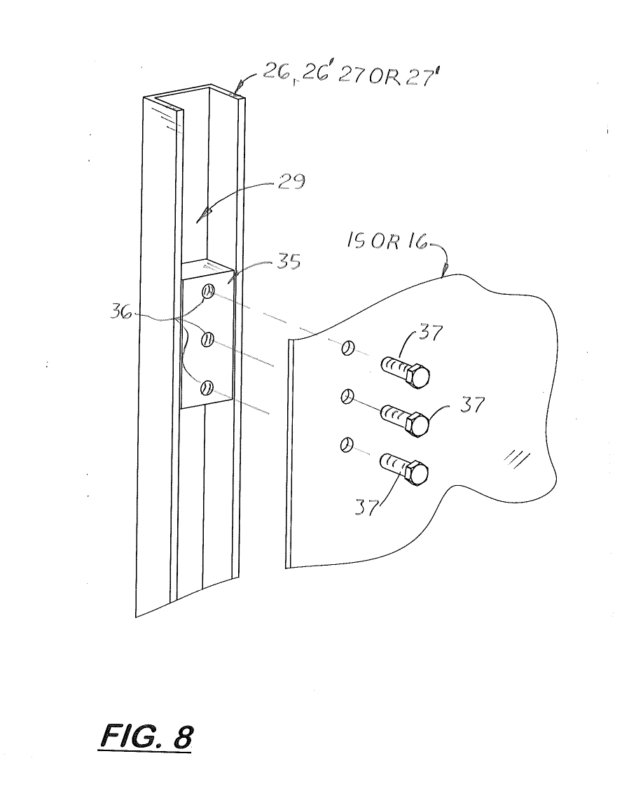

As shown in FIGS. 4-6, the electric generator/water wheel unit 12 includes two opposite vertical plates 15, 16 each attached to the pair of legs, 26, 26′, 27, 27′ located on opposite sides of the frame 25, respectively. As shown more clearly, in FIG. 8, each leg 26, 26′, 27, 27′ is U-shaped in cross-section and includes an inner channel 29. Disposed inside the channel 29 is a glide block 35 designed to slide vertically inside the channel 29. Thread bores 36 are formed on the glide block 35 designed to connected to threaded bolts 38 that extend from the vertical plate 15 or 16. The lower horizontal struts 37 extend between the lower ends of two legs located on opposite sides of the channel 94. The assembly, the struts 37 are connected to the bottom surface of the channel 94 to hold the lower portion of the frame 25 inside the channel 94. In some instances optional weights may be used to anchor the lower portion of the frame 25 inside the channel 94.

Located between the two vertical plates 15, 16 is a water wheel assembly 14 and a coaxially aligned, low RPM electric generator 40. The water wheel unit assembly 14 includes two opposite first and second end plates 17, 18. Located transversely between the two end plates 17, 18 are a plurality of evenly spaced apart, transversely aligned vanes 24. The vanes 24 are concave in cross-section and aligned in the same direction substantially perpendicular to the flow of the water 90 in the channel 94 so that the water wheel assembly 14 automatically rotates in water 90 as it flows downward in the channel 94. The water wheel assembly 14 is aligned on the frame 25 so that the vanes 24 ‘cupped’ as the water 90 flows through the channel 94. When the unit 14 is to be installed in a water channel 94 with a spillway 91, two rearward extending feet 35, 35′ are attached to the two rear lets 26′, 27′ and used to position the two legs 26′, 27′ against the vertical surface on the spillway 91 so that the water 90 flowing over the spillway 91 optimally rotates the water wheel assembly 12. During assembly, the feet 35, 35′ may be connected to the vertical surface under the spillway 91 to anchor the lower portion of the frame 25 inside the channel 94. In the embodiment shown in the Figs, nine vanes 24 are equally spaced apart between the two end plates.

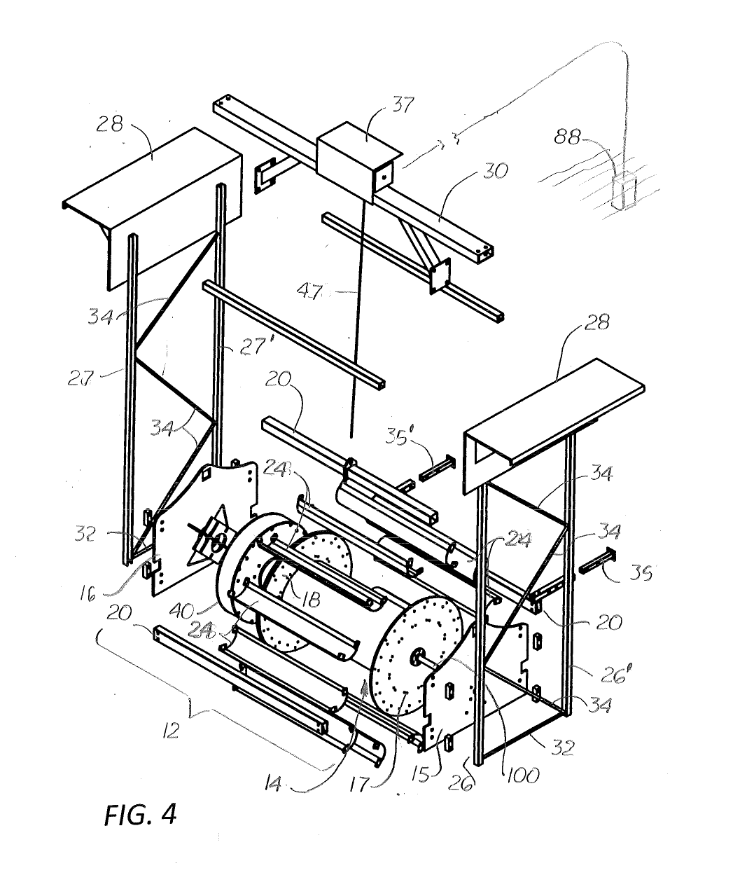

Extending between the first and second end plates 17 and 18, is an axle 100. One end of the axle 100 extends through the first end plate 17 and connects to a hub 21 (see FIGS. 3 and 4), that extends inward and is centrally aligned on the first vertical plate 15. The opposite end of the axle 100 attaches to the second end plate 18. As shown in FIGS. 3 and 6, attached to the outside surface of the second end plate 18 is circular connection plate 39. Connected to the connection plate 39 is a coaxially aligned low RPM electric generator 40.

The electric generator 40 is a low RPM, axial aligned electrical generator substantially identical to the low RPM axial generator disclosed in U.S. patent applications Ser. Nos. 12/228,316, filed on Aug. 11, 2008 and 12/698914, filed Feb. 2, 10 which are now incorporated by reference herein. The electric generator 40 is designed to produce 5 to 10 kw of electrical power.

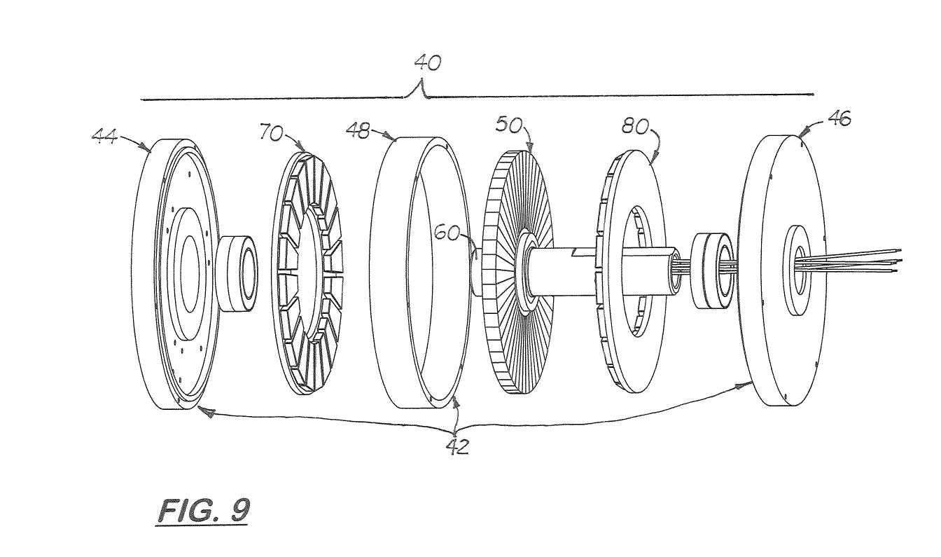

As shown in FIG. 9, the electric generator 40 includes an outer casing 42 made up of two opposite end housing plates 44, 46 located on opposite sides on an intermediate ring member 48. Mounted on the inside surfaces of the two end housing plates 44, 46 are two parallel magnetic discs 70, 80. The two magnetic discs 70, 80 are spaced apart by a center gap in which a stationary stator disc 50 is disposed. The stator disc 50 includes a plurality of looped coil members radially aligned and embedded therein. When the water wheel assembly 14 and the outer casing 42 are rotated around the stator disc 50, a three phase A.C. electric current is produced.

The end housing plate 44 is attached to the connection plate 39 attached to the end plate 18. When the water wheel assembly 14 rotates, the entire outer casing 42 rotates therewith. Coaxially aligned with the outer casing 42 and the stator disc 50 is a hollow shaft 60 that extends between a support hub 62 attached to the inside surface of the second vertical plate 18. The stator disc 50 is securely attached to the axle 60.

The stator disc 50 is made of non-metallic material such as fiberglass. Each coil track loop is made of copper which is radially aligned in the stator disc 50. During operation, the stator disc 50 becomes hot. To reduce heat an optional feature, an optional means for cooling the stator disc may also be provided. In one embodiment, the means for cooling is a loop conduit that is wound in a spiral configuration inside the stator disc 50 which is shown and described by the inventor in U.S. Pat. No. 7,969,035, and also incorporated herein by reference. During use, a coolant continuously flows into the conduit through the track loops and then outward to a cooling radiator (not shown) to remove excess heat from the stator disc 50.

In should be understood that the low RPM electric generator 40 disclosed herein is not limited to the low RPM generator 40 described above and in the above referenced patent application and U.S. Patent. Other types high torque, low RPM generators are available today and may be used.

In one embodiment, the electric generator/water wheel unit 12 includes an optional raising and lowering feature that allows the electric generator/water wheel unit 12 to be raised or lowered on the frame 25 so that the unit 12 may be raised or lowered on the frame 25 according to the level of water 90 in the channel 94. Attached to the horizontal support member 30 is an electric winch 37 with a cable 47 attached thereto that extends downward and connects to a center strut on the electric generator/water wheel unit 12. The electric winch 37 may be connected to a water level monitoring device, such as a float 88, that automatically activates the electric winch 37 to raise or lower the water wheel assembly on the frame 25 according to the level of the water 90. During operation, the float 88 monitors the level of the water 90 in the channel 94 and automatically activates the winch 37 to raise or lower the water wheel assembly 14 on the frame 25 so that the vanes 24 on the water wheel assembly 14 are optimally position for rotation.

The electrical generator 40 is connected to an adjustable inverter 600. The inverter 600 includes electronics (hardware) and a software program 620 that allows the operator to adjust the amount of load exerted by the generator 40. During operation, the amount of water flowing in the channel can vary. If the amount of water is increased, the generator rotates faster and produces higher voltage. In order to optimize the electrical power generated at the greater flow rate, the amperage of the generator is increased by the inverter 600. When the amount of water is decreased, the generator rotates slower and produces lower voltage. The amperage of the generator 40 is decreased by the inverter 600.

When initially installed, the average flow and volume of water 90 and the level of the water 90 in the channel 94 is determined. After the frame 25 is positioned in the channel 94, the relative location of the water wheel assembly 14 on the frame 25 is then determined. During use, the level of the water 90 in the channel 94 is then constantly monitored and the relative location of the water wheel assembly 14 is automatically adjusted on the frame 25 so that vanes 24 are optimally located in the flow of the water at all times.

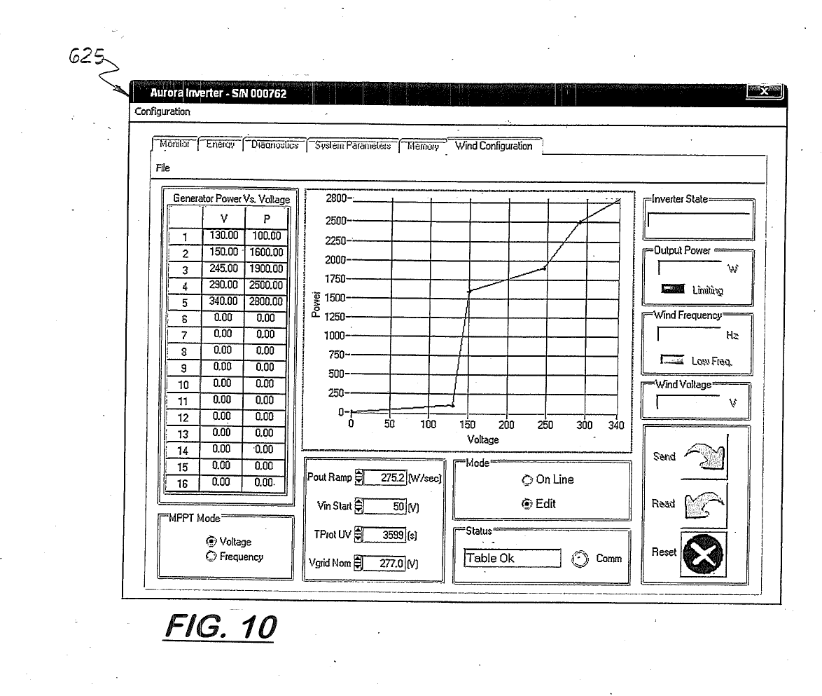

Prior to installation, a flow stream analysis of the water to measure the water level, the volume and the velocity of the water 90 in the water channel 94. After the flow stream analysis is conducted, the depth of the vanes 24 for optimal rotation is determined. A portable computer 700 (i.e. laptop) with a maximum power point tracking software program 620 (known as a MPPT software program) loaded into its memory. Such programs are commonly available through companies that manufacture electrical inverters. The portable computer 700 is then connected to a communication port on the inverter 600. The software program 620 is then executed and the electrical power output and velocity and volume values are inputted to the portable computer 700. The software program 620 generates the menu page 10 shown in FIG. 10, and the operator then uses the software program 620 to adjust the amount of load (amperage) exerted by the inverter 600 on the generator 40 so that the electric generator 40 constantly operates efficiently.

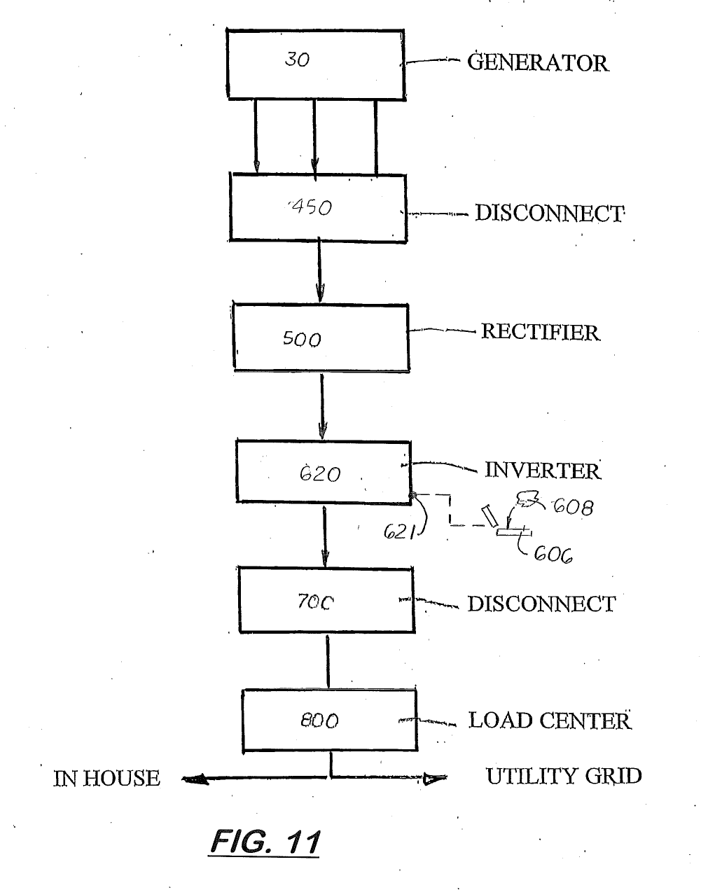

FIG. 11 is a flow chart that shows how the wind generator 10 is connected is a utility grid or to the building electrical system. The generator 40 is connected to a disconnect switch 400. The disconnect switch 400 is connected to a rectifier 500 which is connected to the inverter 600. The inventor 600 is connected to a second disconnect switch 700 and then to a load center 800. The load center 800 is then connected to the utility gird or to the building's electrical system to supply A.C. current thereto.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A water generator system for producing electricity from water flowing a U-shaped channel, comprising:
a. a narrow frame with a four vertical legs designed to be lowered into a U-shaped channel in which a stream of water flows, said frame includes an upper portion and a lower portion;
b. a water wheel assembly transversely aligned and adjustably mounted on said frame, said water wheel assembly includes two vertical end plates and a plurality of transversely aligned fixed vanes extending therebetween, said water wheel being configured so that when said water wheel is rotated, said vanes on said water wheel assembly contact the water and rotate;
c. a low RPM electric generator axially aligned and connected to said water wheel assembly; and,
d. an adjustable inverter that allows an operator to adjust the output of the generator load according to the actual volume and flow rate of the water.

2. The water generator system as recited in claim 1, wherein said water wheel assembly and said electric generator may be selective lower or raised on said frame;

3. The water generator system as recited in claim 2, further including a winch connected to said water wheel assembly and said electric generator coupled to a float that measures the level of the water flowing into said channel so that the location of said vanes in said water are automatically adjusted.

4. The water generator system as recited in claim 1, wherein said low RPM generator includes a cylindrical an outer housing attached to at least one said rotating side plate on said fan assembly, said generator includes a center axle with a stationary stator disc aligned therewith, said stator disc including a plurality of coil members radially aligned and embedded therein, said coil members being serially connected together with wires that extend into said drive axle, said generator also including two magnetic discs located inside said outer housing and coaxially aligned with said stator disc, each said magnetic disc having a plurality of magnets mounted on its inside surface, said magnets on said magnetic disc having opposite polarities so that when said fan assembly rotates, an electric current is produced in said stator disc.

5. A method for converting the flow of water from a water handling facility into electricity comprising the following steps:
a. selecting a water handling facility that has a U-shaped channel in which water flows;
b. selecting a water generator system that includes a narrow frame with a four vertical legs designed to be lowered into a U-shaped channel, a water wheel assembly transversely aligned and adjustably mounted on said frame, said water wheel assembly includes two vertical end plates and a plurality of transversely aligned fixed vanes extending therebetween, said water wheel being configured so that when said water wheel is rotated, said vanes on said water wheel assembly contact the water and rotate, a low RPM electric generator axially aligned and connected to said water wheel assembly, and adjustable inverter that allows an operator to adjust the output of the generator load according to the actual volume and flow rate of the water.
c. mounting said water generator system in said u-shaped channel so that said the water flowing in said u-shaped channels causes said water wheel assembly to rotate;
d. connected said electric generator to an electricity distribution system; and,
e. flowing water through said channel to produce electricity.
